(19) United States
(12) Patent Application Publication
(10) Pub. No.: US 2026/0094562 A1
(43) Pub. Date: Apr. 2, 2026

(54) LED DISPLAY DEVICE AND LED MODULE CONNECTION METHOD

(71) Applicant: Sharp Display Solutions, Ltd., Tokyo (JP)

(72) Inventor: Ryoji TAKAHASHI, Tokyo (JP)

(21) Appl. No.: 19/410,696

(22) Filed: Dec. 5, 2025

Related U.S. Application Data
(63) Continuation of application No. PCT/JP2023/034415, filed on Sep. 22, 2023.

(51) Int. Cl. G09G 3/32

(52) U.S. Cl. CPC G09G 3/32; G09G 2330/021

(57) ABSTRACT

In an LED module and an LED module connected thereto in a next stage, a first path through which a signal processing unit of the LED module and a signal processing unit of the LED module are connected to each other and a signal including an image signal is supplied, a second path which is connected to the signal processing unit of the LED module and LED modules in next and succeeding stages of the LED module and through which a power supply control signal for supplying power from a power supply unit of a supply target LED module among the next and succeeding stages to the signal processing unit of the target LED module is supplied, and a third path through which a power supply unit of the LED module and a power supply unit of the LED module are connected to each other and power supplied from the outside to the power supply unit of the LED module is supplied to the power supply unit of the LED module.

### BACKGROUND OF THE INVENTION

### FIELD OF THE INVENTION

The present invention relates to an LED display device and a LED module connection method.

### DESCRIPTION OF RELATED ART

There is an LED display device that is equipped with a plurality of light emitting diode (LED) modules to display an image in response to an image signal. A power supply device is connected to such an LED display device, and power is supplied from the power supply device to the LED display device. The power supplied from the power supply device is supplied to each LED module of the LED display device.

In a lighting device including a light emitting element, there is a cutoff circuit that cuts off power, which is supplied to the light emitting element, on the basis of control from a control circuit (for example, see Patent Document 1).

### [Patent Documents]

[Patent Document 1] Japanese Unexamined Patent Application, First Publication No. 2022-036630

### SUMMARY OF THE INVENTION

However, in an LED display device, in a case in which power is supplied from a power supply device, a circuit in an LED module operates and consumes power even in a state in which no image is displayed.

Patent Document 1 is intended to suppress dim lighting of a light source when a light is turned off and is not intended to reduce the power consumption of an LED module.

According to an aspect of the present invention, there is provided an LED display device in which a plurality of LED modules are arranged, the LED module including a display unit on which a plurality of LED elements are mounted, a signal processing unit that causes the display unit to display an image based on an image signal supplied from an external device, and a power supply unit that supplies power supplied from the outside to at least the signal processing unit, the LED display device including: in a first LED module and a second LED module connected to the first LED module among the plurality of LED modules, a first path that is a path through which a signal processing unit of the first LED module and a signal processing unit of the second LED module are connected to each other and a signal including an image signal is supplied; a second path that is a path through which the signal processing unit of the first LED module and a power supply unit of the second LED module are connected to each other and a power supply control signal for supplying power from the power supply unit of the second LED module to the signal processing unit of the second LED module is supplied; and a third path that is a path through which a power supply unit of the first LED module and the power supply unit of the second LED module are connected to each other and power supplied from the outside to the first LED module is supplied to the power supply unit of the second LED module.

In addition, according to another aspect of the present invention, there is provided a method of connecting a first LED module and a second LED module to be connected thereto in a stage next after the first LED module to each other among a plurality of LED modules in an LED display device in which the plurality of LED modules are arranged, the LED module including a display unit on which a plurality of LED elements are mounted, a signal processing unit that causes the display unit to display an image based on an image signal supplied from an external device, and a power supply unit that supplies power supplied from the outside to at least the signal processing unit, the method including: connecting a signal processing unit of the first LED module and a signal processing unit of the second LED module to each other through a first path to supply a signal including an image signal through the first path; connecting the signal processing unit of the first LED module and a power supply unit of the second LED module to each other through a second path and supplying a power supply control signal for supplying power from the power supply unit of the second LED module to the signal processing unit of the second LED module through the second path; and connecting a power supply unit of the first LED module and the power supply unit of the second LED module to each other through a third path and supplying power supplied from the outside to the power supply unit of the first LED module to the power supply unit of the second LED module through the third path.

According to the present invention, it is possible to reduce power consumption in a state in which no image is displayed.

### BRIEF DESCRIPTION OF THE DRAWINGS

FIG. 1 is a schematic configuration diagram showing a display system S that includes an LED display device according to the present embodiment.

FIG. 2 is a schematic configuration diagram showing a configuration of a LED display device 1.

FIG. 3 is a side view of one LED module 10 as viewed from the side.

FIG. 4 is a schematic functional block diagram illustrating a configuration of a first LED module and a second LED module.

FIG. 5 is a functional block diagram illustrating a function of a power supply unit 10d11.

FIG. 6 is a functional block diagram illustrating a function of a power supply unit 10d11.

FIG. 7 is a functional block diagram showing a configuration of an LED module 10-21a.

FIG. 8 is a diagram showing a specific example of a configuration of a delay circuit 10e.

FIG. 9 is a functional block diagram showing a schematic configuration of a signal processing unit 10c11.

FIG. 10 is a functional block diagram showing a schematic configuration of a signal processing unit 10c11-1.

FIG. 11 is a schematic functional block diagram illustrating a configuration for outputting a power supply control signal.

FIG. 12 is a schematic functional block diagram illustrating another example of a configuration in which an LED module 10-11 outputs a power supply control signal.

FIG. 13 is a functional block diagram showing another configuration of the LED module 10.

FIG. 14 is a diagram showing an example of calculation of power consumption of the LED display device.

### DETAILED DESCRIPTION OF THE INVENTION

Hereinafter, an LED display device according to embodiments of the present invention will be described with reference to the drawings.

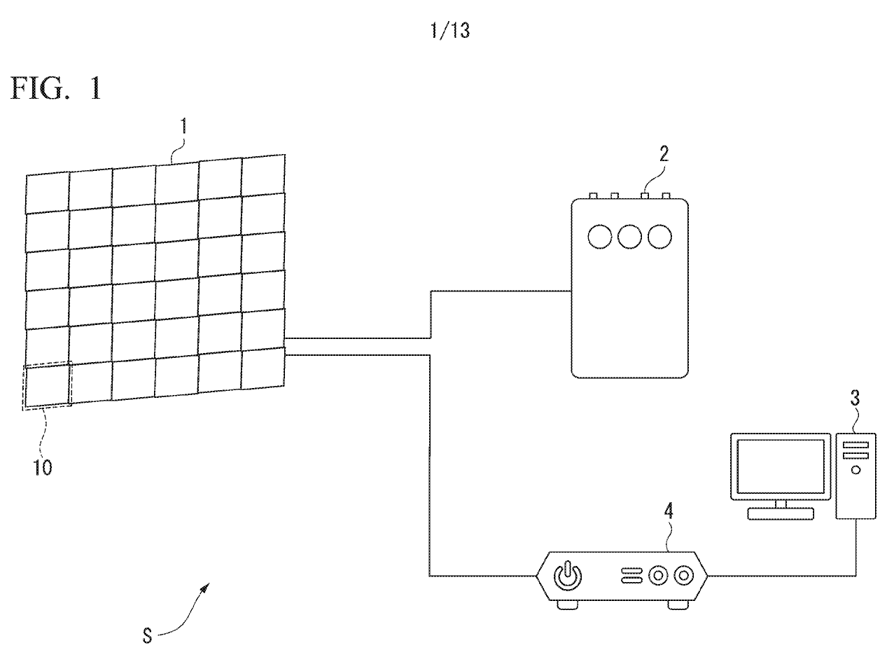

FIG. 1 is a schematic configuration diagram showing a display system S that includes an LED display device according to the present embodiment.

The display system S includes an LED display device 1, a power distribution board 2, an image signal supply device 3, and an LED controller 4.

The LED display device 1 is connected to the power distribution board 2 via a power supply line and receives power from the power distribution board 2. In addition, the LED display device 1 is connected to the LED controller 4 via a communication line.

The LED display device 1 includes a plurality of LED modules 10. In the LED display device 1, the plurality of LED modules 10 are disposed to be adjacent to each other to be aligned in a longitudinal direction and a lateral direction. In this drawing, the plurality of LED modules 10 are arranged in a matrix of six in the longitudinal direction and six in the lateral direction, and thus a total of 36 LED modules 10 are disposed.

The LED display device 1 uses the entire display area of such a plurality of LED modules to display an image based on an image signal.

The power distribution board 2 supplies power to the LED display device 1. The supplied power is, for example, alternating current (AC) power.

The image signal supply device 3 is a supply source that is connected to the LED controller 4 via a communication line and outputs an image signal to the LED controller 4. The specifications of the communication line through which the image signal supply device 3 and the LED controller 4 are connected to each other correspond to one of the standards such as DVI I/F and HDMI (a registered trademark) I/F.

The image signal supply device 3 may be, for example, a computer.

The LED controller 4 supplies various signals to the LED module. The various signals include, for example, an image signal and an activation signal. The LED controller 4 is an example of an external device.

The LED controller 4 outputs the image signal output from the image signal supply device 3 to the LED display device 1. For example, the LED controller 4 divides the image signal output from the image signal supply device 3 in accordance with a configuration in which the LED modules 10 are arranged, converts the divided image signal into an image signal in a format which can be received by the LED module 10, and outputs the converted image signal to the LED module.

In addition, the LED controller 4 has a Wake-on-LAN function, generates a Wake-on-LAN packet representing the various signals, and transmits the Wake-on-LAN packet. The various signals transmitted by the LED controller 4 include, for example, an activation signal, an OFF command, and the like. The activation signal may be, for example, a Wake-on-LAN (WOL) command or an ON command. The activation signal is a control signal that indicates an instruction to activate the LED module. The OFF command is a command for instructing that an image based on the image signal should not be displayed.

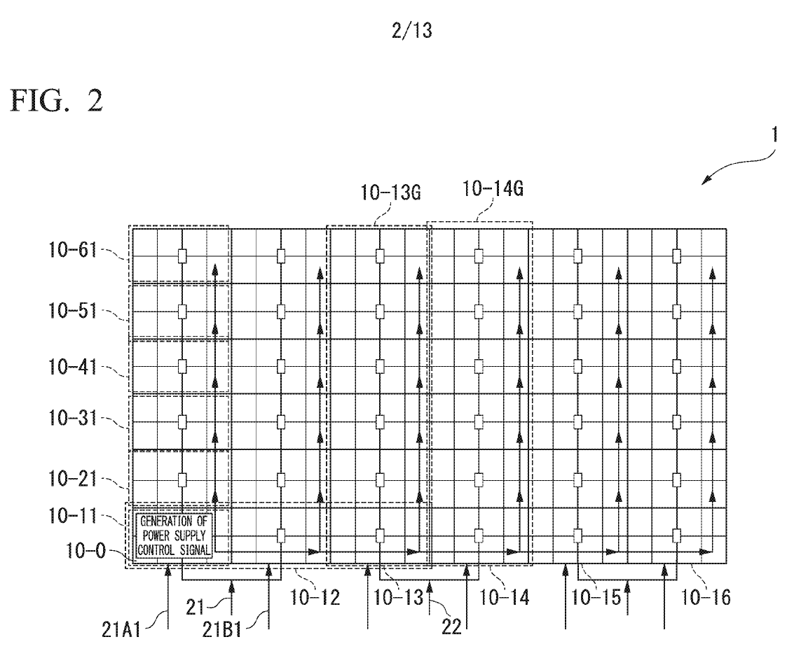

FIG. 2 is a schematic configuration diagram showing a configuration of the LED display device 1.

In the LED display device 1, the LED modules 10 are arranged in a matrix of six in the longitudinal direction and six in the lateral direction, and thus a total of 36 LED modules 10 are disposed.

One LED module (for example, an LED module 10-11) is configured to include a plurality of pixel cards 10-0.

For example, the LED module 10-11 is disposed in the lowest stage (a first stage) in the most left row (a first row), and an LED module 10-21, an LED module 10-31, an LED module 10-41, an LED module 10-51, and an LED module 10-61 are arranged in that order on the upper stage of the LED module 10-11 and are electrically connected in series.

In addition, an LED module 10-12, an LED module 10-13, . . . are arranged in that order on the right side of the LED module 10-11.

Here, the LED modules 10 in each row are connected in series to the LED modules 10 adjacent in the longitudinal direction through a communication cable (for example, a local area network (LAN) cable). In addition, the LED module 10 in a first stage in each row is connected to the LED controller 4 via a communication cable (for example, a LAN cable). More specifically, the LED module 10-11 is electrically connected to the LED controller 4 via a communication cable 21A1, and the LED module 10-12 is electrically connected to the LED controller 4 via a communication cable 21B1. As a result, the various signals (at least any one of the activation signal and the image signal) output from the LED controller 4 are supplied to the LED module 10 in the first stage in each row. The LED module 10 in the first stage in each row outputs the various signals to the LED module 10 connected thereto in a stage next thereafter via a communication cable. As a result, the various signals (the activation signal, the image signal, and the like) are transmitted sequentially from the LED module 10 in the first stage to a LED module 10 in the last stage in each row.

In addition, among the LED modules 10 in the lowest stage in each row of the LED modules 10, two adjacent LED modules 10 are connected to the power distribution board 2 and are supplied with AC power. For example, a power supply line 21 connected to the power distribution board 2 is connected to each of the LED module 10-11 and the LED module 10-12. As a result, the AC power is supplied to a module group in a first row which includes the LED module 10-11 and a module group in a second row which includes the LED module 10-12 through the power supply line 21.

In addition, a power supply line 22 connected to the power distribution board 2 is connected to each of the LED module 10-13 and the LED module 10-14. As a result, the AC power is supplied to a module group 10-13G in a third row which includes the LED module 10-13 and a module group 10-14G in a fourth row which includes the LED module 10-14 through the power supply line 22. Similarly, the LED module 10-15 and the LED module 10-16 are connected to the power distribution board 2.

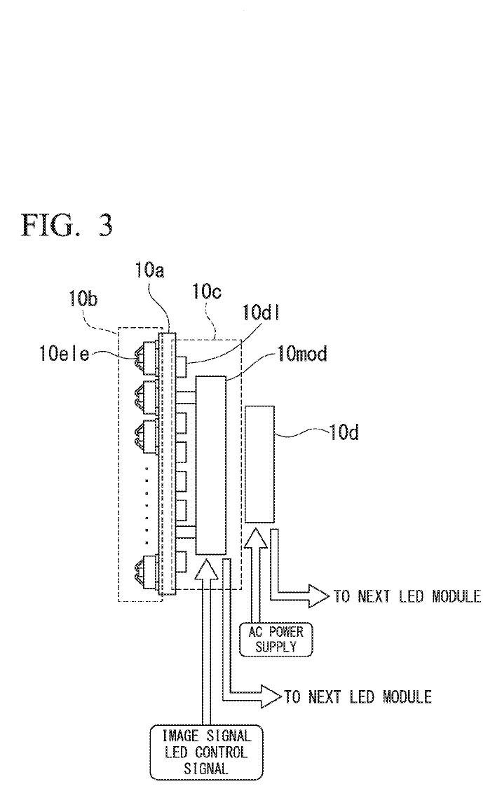

FIG. 3 is a side view of one LED module 10 as viewed from the side.

In the LED module 10, a display unit 10b is formed on a first surface of an LED substrate 10a. In the display unit 10b, a plurality of LED elements 10ele are mounted on the first surface of the LED substrate 10a.

One of the LED elements 10ele constitutes one pixel.

A signal processing unit 10c and a power supply unit 10d are attached to a second surface of the LED substrate 10a, which is a surface opposite to the first surface.

The signal processing unit 10c is connected to the LED controller or a signal processing unit of an LED module in a previous stage, processes an image signal received from the LED controller or the signal processing unit of the LED module in the previous stage, drives the LED elements of the display unit 10b, and causes the LED elements to display an image in response to the image signal.

The signal processing unit 10c includes an LED driver IC 10dl and a signal processing module 10mod.

The LED driver IC 10dl is connected to at least one of the LED elements 10ele and lights up the connected LED element 10ele in response to the image signal.

The signal processing module 10mod performs processing of the various signals.

In addition, the signal processing unit 10c is connected to the LED module 10 in the previous stage or the LED controller 4, receives the image signal output from the LED controller 4, and outputs the image signal to an LED module 10 connected thereto in a subsequent stage in the same row to which the LED module 10 itself belongs.

When the AC power is supplied from the power distribution board 2, the power supply unit 10d converts the AC power into DC power and supplies the converted DC power to each circuit of the LED module.

In addition, the power supply unit 10d converts the power into power having a voltage suitable for each of the display unit 10b and the signal processing unit 10c and supplies the converted power to each of the display unit 10b and the signal processing unit 10c.

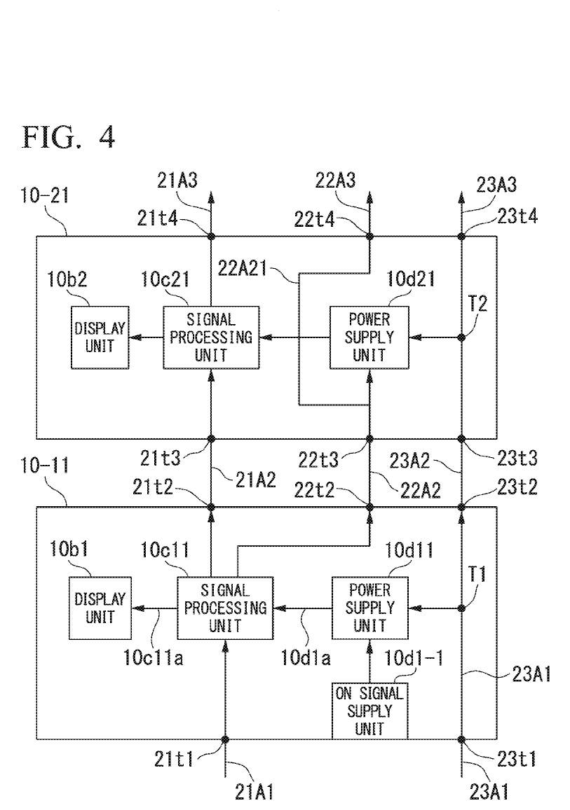

FIG. 4 is a schematic functional block diagram illustrating a configuration of a first LED module and a second LED module connected thereto in a stage next after the first LED module, among the plurality of LED modules 10. Here, for example, a case in which the first LED module is the LED module 10-11 and the second LED module is the LED module 10-21 will be described.

The LED module 10-11 includes a power supply unit 10d11, a signal processing unit 10c11, and a display unit 10b1. In addition, the LED module 10-11 has a terminal 21t1, a terminal 23t1, a terminal 21t2, a terminal 22t2, and a terminal 23t2.

The LED module 10-21 includes a power supply unit 10d21, a signal processing unit 10c21, and a display unit 10b2. In addition, the LED module 10-21 has a terminal 21t3, a terminal 22t3, a terminal 23t3, a terminal 21t4, a terminal 22t4, and a terminal 23t4.

In this manner, a plurality of LED modules, each of which includes a display unit, a signal processing unit, and a power supply unit, are arranged in the LED display device 1.

The terminal 23t1 is connected to a power supply line 23A extending from the outside of the LED module 10-11. An end portion of the power supply line 23A other than an end portion thereof connected to the terminal 23t1 is connected to the power distribution board 2. As a result, the power is supplied from the power distribution board 2 to the terminal 23t1.

The terminal 23t1 and the terminal 23t2 are connected to each other through a power supply line 23A1. A power supply line branched off from the power supply line 23A1 is connected between a connection point T1 of the power supply line 23A1 and the power supply unit 10d11. As a result, the AC power supplied from the power distribution board 2 is supplied to the power supply unit 10d11.

The power supply unit 10d11 receives the AC power from the power distribution board 2 via the power supply line branched off from the power supply line 23A1, converts the AC power into DC power, and supplies the converted DC power to the signal processing unit 10c11 via a connection line 10d1a. The signal processing unit 10c11 can be driven with the power supplied via the connection line 10d1a.

Here, the power supply unit 10d11 is provided with a switching unit that switches between supplying and not supplying the power to the signal processing unit 10c11 (which will be described below). In this drawing, an ON signal supply unit 10d1-1 that supplies an ON signal to the switching unit of the power supply unit 10d11 of the LED module 10 in the first stage to which the AC power is supplied is provided, where the ON signal is for switching the switching unit such that the power is supplied to the signal processing unit 10c11. For this reason, the power supply unit 10d11 supplies the DC power to the signal processing unit 10c11 in response to the supply of the AC power through the power supply line 23A1.

The terminal 23t2 and terminal 23t3 are connected to each other through a third path 23A2. As a result, a power supply line between the terminal 23t1 and the terminal 23t2 of the LED module 10-11 and a power supply line between the terminal 23t3 and the terminal 23t4 of the LED module 10-21 are electrically connected to each other. The power supply unit 10d11 is connected to the power supply line between the terminal 23t1 and the terminal 23t2 of the LED module 10-11. The power supply unit 10d21 is connected to the power supply line between the terminal 23t3 and the terminal 23t4 of the LED module 10-21. The third path is, for example, a power line through which the AC power can be supplied.

In other words, the third path is a path through which the power supply unit of the first LED module and the power supply unit of the second LED module are connected to each other and the power supplied from the outside to the first LED module is supplied to the power supply unit of the second LED module.

For example, the third path 23A2 connects the power supply unit 10d11 of the LED module 10-11 and the power supply unit 10d2 of the LED module 10-21 to each other, and the power supplied from the power distribution board 2 to the LED module 10-11 is supplied to the power supply unit 10d2 through the third path 23A2.

A third path 23A3 connects the power supply unit 10d21 of the LED module 10-21 and a power supply unit of the LED module 10-31 to be connected thereto in the next stage after the LED module 10-21 to each other, and the power supplied from the power distribution board 2 is supplied to the power supply unit through the third path 23A3.

The third path is, for example, a power line through which the power can be supplied. In addition, the third path may be any path through which the power can be supplied and may be, for example, a cable having a set of three lines of a live line, a neutral line, and a ground line.

A case in which the third path is a path that connects a terminal of an LED module and a terminal of an LED module 10 in the next stage after the LED module to each other has been described, but the third path may also be a path that connects a power supply unit of an LED module and a power supply unit of an LED module 10 in the next stage after the LED module to each other.

In the outside of the LED module 10-11, the communication cable 21A1 is connected to the terminal 21t1 of the LED module 10-11. An end portion of the communication cable 21A1 other than an end portion thereof connected to the terminal 21t1 is connected to the LED controller 4. As a result, an activation signal (a Wake-on-LAN packet) is supplied from the LED controller 4 to the terminal 21t1.

When the signal processing unit 10c11 receives the activation signal from the LED controller 4, the signal processing unit 10c11 generates a power supply control signal and supplies the generated power supply control signal to the power supply unit 10d2 of the LED module 10-21 connected thereto in the subsequent stage via a second path 22A2. Here, the LED controller 4 transmits the activation signal as the Wake-on-LAN packet to the signal processing unit 10c11 of the LED module 10-11. The signal processing unit 10c11 transmits the activation signal to the LED module 10 in the subsequent stage via the second path to turn on the power supply unit of the LED module 10 in the subsequent stage.

A case in which the Wake-on-LAN packet is used as the activation signal has been described, but, as long as it is possible to turn on a power supply, a unique ON command predetermined between the LED controller 4 and the signal processing unit 10c11 may be used instead of the Wake-on-LAN packet.

The power supply control signal may be any signal that can cause the power supply unit 10d2 to supply power to the signal processing unit 10c2.

A first connection line of the signal processing unit 10c11 is connected to the terminal 22t2.

The terminal 22t2 and terminal 22t3 are communicatively connected to each other through the second path 22A2.

In other words, the second path is a path connected to the signal processing unit of the first LED module and any one of the LED modules in next and succeeding stages of the first LED module, and a power supply control signal for supplying the power from a power supply unit of a supply target LED module among the LED modules in the next and succeeding stages to a signal processing unit of the target LED module is supplied through the second path.

For example, the second path 22A2 connects the signal processing unit 10c11 of the LED module 10-11 and the power supply unit 10d2 of the LED module 10-21 to each other, and the power supply control signal supplied from the signal processing unit 10c11 is supplied to the power supply unit 10d2 through the second path 22A2.

A second path 22A3 is a path through which the power supply control signal output from the signal processing unit 10c11 of the LED module 10-11 is supplied to the power supply unit of the LED module 10-31 connected thereto in the next stage after the LED module 10-21. Here, in the LED module 10-21, a supply path 22A21 is provided between the terminal 22t3 and the terminal 22t4 to electrically connect the two terminals to each other, and the power supply control signal supplied from the signal processing unit 10c11 is supplied to the LED module 10-31 in the next stage via the second path 22A3.

A case in which the second path is a path that connects a terminal of an LED module and a terminal of an LED module 10 in the next stage after the LED module to each other has been described, but the second path may also be a path that connects a signal processing unit of an LED module and a power supply unit of an LED module 10 in the next stage after the LED module to each other.

The second path may be any path that is connected to the signal processing unit of the first LED module and any one of the LED modules in the next or succeeding stages of the first LED module. In this case, the LED modules in the next and succeeding stages may be LED modules adjacent to the first LED module. In addition, the LED modules in the next and succeeding stages may be LED modules that are disposed not to be adjacent to the first LED module among a plurality of arranged LED modules (for example, the LED module in the third stage, the LED module in the fourth stage, and the like in the same row to which the first LED module belongs).

Each of the second path 22A2 and the second path 22A3 is, for example, a signal line through which the power supply control signal can be transmitted. Each of the second path 22A2 and the second path 22A3 may be any path through which the power supply control signal can be transmitted and may be, for example, a cable having a set of two lines including a line representing HI or LOW and a ground line.

In a case in which the LED module 10-11 is activated and then the LED module 10-11 is turned off, a unique OFF command may be set in advance between the LED controller 4 and the signal processing unit 10c11, and this OFF command may be used. For example, when the signal processing unit 10c11 receives the OFF command from the LED controller 4, the signal processing unit 10c11 generates a power supply control signal including an instruction to stop the supply of power and transmits the generated power supply control signal to the power supply unit 10d2 of the LED module 10-12 in the subsequent stage via the second path. As a result, in response to receiving the power supply control signal including an instruction to stop the supply of power, the power supply unit 10d2 stops an operation thereof and also stops the supply of power to the signal processing unit 10c2.

A second connection line of the signal processing unit 10c11 is connected to the terminal 21t2.

The terminal 21t2 and terminal 21t3 are communicatively connected to each other through a first path 21A2.

In other words, the first path is a path through which a signal processing unit of the first LED module and a signal processing unit of the second LED module are connected to each other and a signal including an image signal is supplied.

The first path is, for example, a communication cable. As the communication cable, for example, a LAN cable can be used.

The first path 21A2 connects the signal processing unit 10c11 of the LED module 10-11 and the signal processing unit 10c2 of the LED module 10-21 to each other, and at least any one of an image signal and an activation signal is supplied to the signal processing unit 10c2 through the first path 21A2. In addition, the first path 21A3 connects the signal processing unit 10c2 of the LED module 10-21 and the signal processing unit of the LED module 10-22 to each other, and at least any one of an image signal and an activation signal is supplied to the signal processing unit 10c2 through the first path 21A3. In this manner, the first path connects the signal processing units of the adjacent LED modules 10 in each row to each other, and the various signals is supplied through the first path.

A case in which the first path is a path that connects a terminal of an LED module and a terminal of an LED module 10 in the next stage after the LED module to each other has been described, but the third path may also be a path that connects a signal processing unit of an LED module and a signal processing unit of an LED module 10 in the next stage after the LED module to each other.

In this manner, the first path connects the signal processing units of the adjacent LED modules 10 in each row to each other.

When the signal processing unit 10c11 receives the activation signal from the LED controller 4, the signal processing unit 10c11 transmits the activation signal to the signal processing unit 10c2 of the LED module 10-21 in the subsequent stage via the first path 21A2.

A third connection line 10c11a of the signal processing unit 10c11 is connected to the display unit 10b1.

In addition, when the power is supplied from the power supply unit 10d11, the signal processing unit 10c11 supplies the power to the display unit 10b1 via the connection line 10c11a.

The LED module 10-21 includes a power supply unit 10d2, a signal processing unit 10c2, and a display unit 10b2. In addition, the LED module 10-21 has a terminal 21t3, a terminal 22t3, a terminal 23t3, a terminal 21t4, a terminal 22t4, and a terminal 23t4.

Here, the LED module 10-21 has the supply path 22A21 through which the power supply control signal is supplied to a signal processing unit of a third LED module (for example, the LED module 10-31) connected thereto in a stage next after the LED module 10-21.

The supply path 22A21 is connected between the terminal 22t3 and the terminal 22t4, and the power supply control signal is supplied to the second path 22A3 through the supply path 22A21.

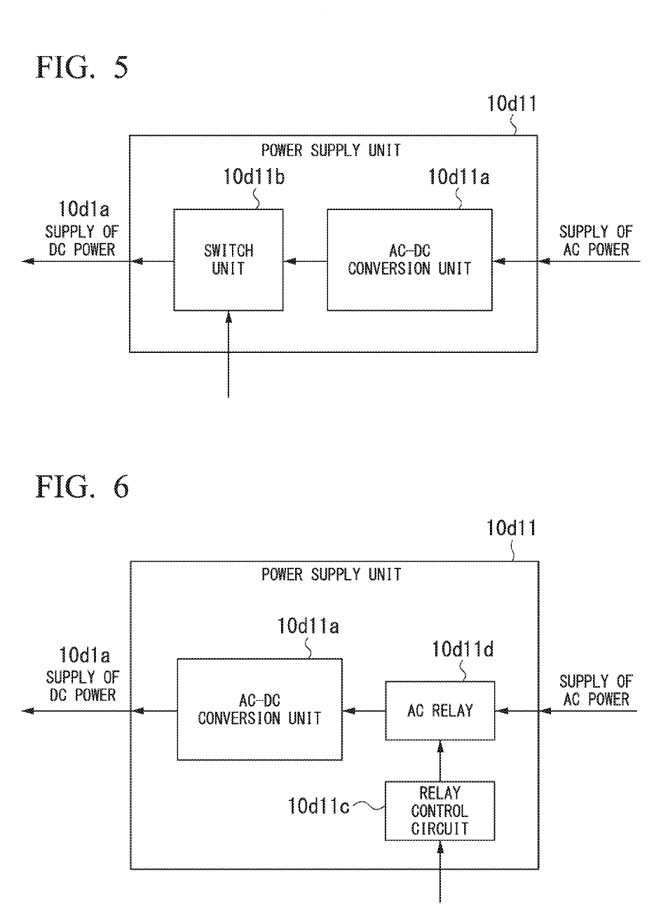

FIG. 5 is a functional block diagram illustrating a function of the power supply unit 10d11.

The power supply unit 10d11 has an AC-DC conversion unit 10d11a and a switch unit 10d11b.

The AC-DC conversion unit 10d11a converts AC power supplied from the outside into DC power and outputs the DC power.

The switch unit 10d11b receives the power supply control signal and switches between supplying and not supplying the DC power to the subsequent stage (the signal processing unit) depending on whether the power supply control signal is ON or OFF. For example, in a case in which the power supply control signal indicates ON, the switch unit 10d11b switches the switch to ON, and thus the DC power output from the AC-DC conversion unit 10d11a is supplied to the subsequent stage (the signal processing unit). In a case in which the power supply control signal indicates OFF, the switch unit 10d11b switches the switch to OFF, and thus the power that is supplied from the AC-DC conversion unit 10d11a to the subsequent stage (the signal processing unit) is cut off.

According to a configuration of the power supply unit 10d11 in this drawing, it is possible to cut off the power that is supplied from the AC-DC conversion unit 10d11a to the signal processing unit in response to the power supply control signal. As a result, it is possible to stop the power that is supplied to the signal processing unit and the display unit in a case in which the LED module 10 is not driven, and thus it is possible to reduce power consumption of the LED module.

FIG. 6 is a functional block diagram illustrating a function of the power supply unit 10d11.

The power supply unit 10d11 has a relay control circuit 10d11c and an AC relay 10d11d.

The AC-DC conversion unit 10d11a converts AC power supplied from the outside into DC power and outputs the DC power.

The relay control circuit 10d11c drives the AC relay on the basis of a relay control signal input from the outside. The relay control circuit 10d11c switches the AC relay 10d11d between ON and OFF depending on whether the relay control signal is ON or OFF, for example. For example, in a case in which the relay control signal indicates ON, the relay control circuit 10d11c switches the AC relay 10d11d to ON, and thus the AC power supplied from the outside is supplied to the AC-DC conversion unit 10d11a. In a case in which the relay control signal indicates OFF, the relay control circuit 10d11c switches the AC relay 10d11d to OFF, and thus the AC power that is supplied from the outside to the AC-DC conversion unit 10d11a is cut off.

The AC relay is connected between an AC power supply and the AC-DC conversion unit 10d11a and switches between ON and OFF states in response to an instruction from the relay control circuit 10d11c.

Here, as the relay control signal, the power supply control signal input from the signal processing unit of the LED module 10 in the previous stage can be used.

According to a configuration of power supply unit 10d11 in this drawing, it is possible to cut off the power that is supplied to the AC-DC conversion unit 10d11a on the basis of the relay control signal at a stage before the power is input to the AC-DC conversion unit 10d11a. In this case, when the power is not supplied to the signal processing unit, it is possible to stop the driving of the AC-DC conversion unit 10d11a, and it is also possible to reduce the power consumption of the AC-DC conversion unit 10d11a.

In addition, the AC relay 10d11d switches between cutting off and supplying the power between the path through which the AC power is supplied and the AC-DC conversion unit 10d11a, and thus there is no need to disconnect the third path through which the AC power is supplied between the LED modules. In order to cut off the power on the third path, it is necessary to use a cut-off circuit with a large current capacity, but in this case, since it is only necessary to cut off the power with respect to the AC-DC conversion unit 10d11a, it is possible to use a cut-off circuit with a small current capacity.

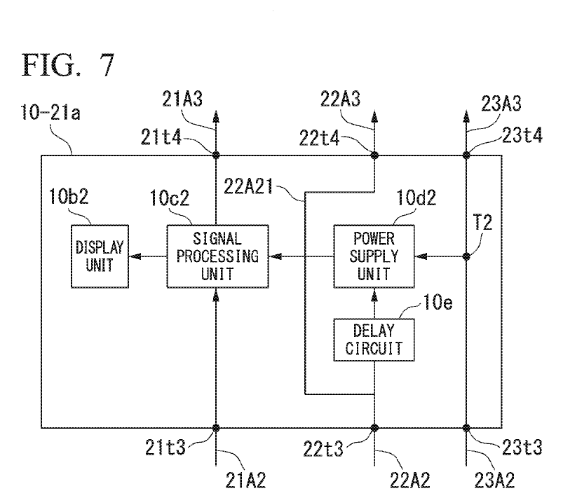

FIG. 7 is a functional block diagram showing a configuration of an LED module 10-21a which is another configuration of the LED module 10-21 connected to any one of second and succeeding stages. Each of the LED modules in the second and succeeding states may have the configuration shown in the LED module 10-21a, or at least one of the LED modules in one row may have the configuration of the LED module 10-21a.

In the LED module 10-21a, the same constituent elements as those in the LED module 10-21 of FIG. 4 are denoted by the same reference signs, and the description thereof will be omitted.

The LED module 10-21a includes a delay circuit 10e.

The delay circuit 10e is connected between a terminal 22t3 and a power supply unit 10d2.

The delay circuit 10e delays the timing at which the power supply control signal supplied from the first LED module (for example, the LED module 10-11 in FIG. 4) reaches the power supply unit (the power supply unit 10d2 in this drawing) of the second LED module (for example, the LED module 10-21a).

Here, the LED module 10-21a has a supply path 22A21 through which the power supply control signal is supplied to a signal processing unit of a third LED module (for example, the LED module 10-31) connected thereto in a stage next after the LED module 10-21a.

The supply path 22A21 is connected between the terminal 22t3 and a terminal 22t4, and the power supply control signal before being input to the delay circuit 10e or the power supply control signal delayed by the delay circuit 10e is supplied via a second path 22A3.

The delay time set in the delay circuit 10e can be set to any desired time.

The delay circuit 10e can delay the timing at which the power supply control signal is input to the power supply unit from the activation timing of the power supply unit based on the power supply control signal in the LED module connected in the previous stage. As a result, it is possible to make the timings at which the power supply units of the plurality of LED modules in the same row activate be different from each other, and thus it is possible to reduce an inrush current in the LED display device 1.

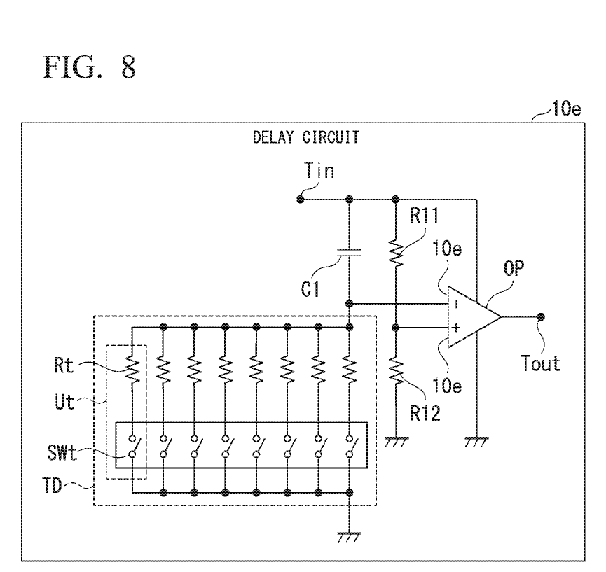

FIG. 8 is a diagram showing a specific example of a configuration of the delay circuit 10e in FIG. 7.

A first terminal of a capacitor C1 is connected to an input terminal Tin, and a second terminal which is another terminal of the capacitor C1 is connected to a delay time setting unit TD. The capacitance of the capacitor C1 may be determined according to the time to be delayed.

The delay time setting unit TD sets the delay time. The delay time setting unit TD includes a plurality of resistors and a plurality of switches. The delay time setting unit TD includes, for example, a plurality of setting units Ut in each of which one resistor Rt and one switch SWt are connected in series. The plurality of setting units Ut are connected in parallel between the second terminal of the capacitor C1 and a connection point connected to the ground.

The resistance values of the plurality of resistors Rt may be different from each other or may be the same. The plurality of switches SWt are physical switches that can be switched between on and off in response to an operation by an operator. As a result, it is possible to set the delay time according to a combination of the on or off state of each of the plurality of switches SWt and the resistance value of the resistor Rt connected to the switch that is turned on.

A first terminal of a resistor R11 is connected to the input terminal Tin, and a second terminal which is another terminal of the resistor R11 is connected to a first terminal of a resistor R12.

The first terminal of the resistor R12 is connected to the second terminal of the resistor R11, and a second terminal which is another terminal of the resistor R12 is connected to the ground.

When the power supply control signal is applied to the terminal Tin, the voltage at a connection point between the resistor R11 and the resistor R12 is maintained at a substantially constant value.

The voltage to be applied to a second input terminal of an operational amplifier OP can be set according to the combination of the resistance value of the resistor R11 and the resistance value of the resistor R12.

A first input terminal of the operational amplifier OP is connected to a connection point between the capacitor C1 and the delay time setting unit TD.

The second input terminal of the operational amplifier OP is connected to the connection point between the resistor R11 and the resistor R12.

A positive power supply terminal of the operational amplifier is connected to the input terminal Tin, and a negative power supply terminal of the operational amplifier is connected to the ground.

The operational amplifier OP compares the voltage input from the first input terminal with the voltage input from the second input terminal and outputs the power supply control signal from an output terminal in a case in which the voltage input from the first input terminal is higher than the voltage input from the second input terminal. In a case in which the voltage input from the first input terminal is equal to or lower than the voltage input from the second input terminal, the operational amplifier OP does not output the power supply control signal from the output terminal.

For example, when the power supply control signal is input to the delay circuit 10e, the voltage at the connection point between the capacitor C1 and the delay time setting unit TD rises according to a combined resistance set in the delay time setting unit TD and the capacitance of the capacitor C1. When the voltage at the connection point between the capacitor C1 and the delay time setting unit TD exceeds the voltage at the connection point between the resistor R11 and the resistor R12, the operational amplifier OP supplies the power supply control signal to the outside. Here, a time period from when the power supply control signal is supplied to the terminal Tin until the power supply control signal is output from the terminal Tout can be changed according to the on or off state of each of the plurality of switches SWt.

Here, it is possible to set a specific delay time for the LED module provided with the delay circuit 10e according to a combination of on and off states of the plurality of switches SWt of the delay time setting unit TD. Here, the delay times of the delay time setting units TD in the plurality of LED modules are set to different values, and thus it is possible to set the timing at which the power supply units of the LED modules activate to be different from each other. Here, in a case in which the timings at which the power supply units of the LED modules activate are same, when the power is supplied to the LED display device 1, the inrush current is likely to occur in the LED display device 1. However, according to this embodiment, even in a case in which the power is supplied to the LED display device 1, the timings at which the power supply units of the LED modules activate are different from each other, and the timings at which the inrush current occurs in each LED module can be deviated from each other, and thus it is possible to reduce the value of the inrush current occurring in the entire LED display device 1.

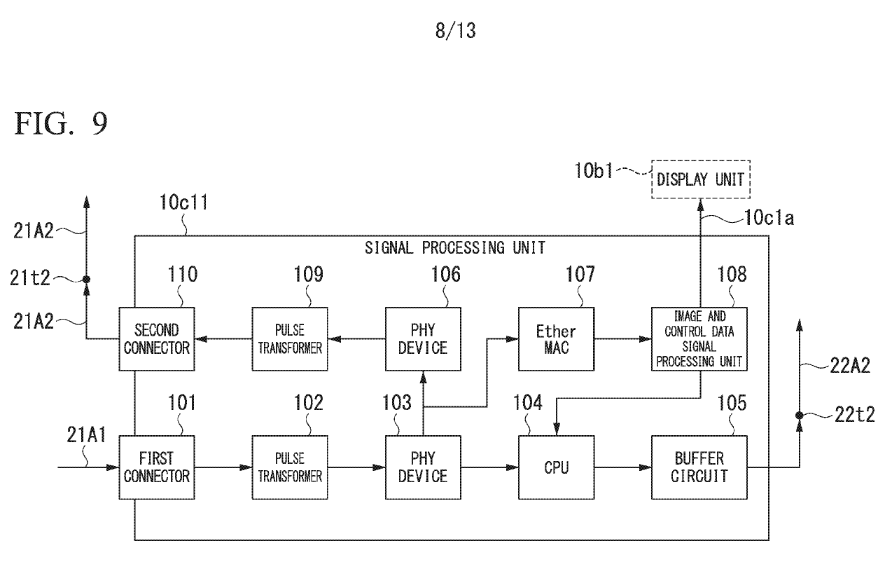

FIG. 9 is a functional block diagram showing a schematic configuration of the signal processing unit 10c11 in FIG. 4.

In the signal processing unit 10c11, a first connector 101 is, for example, a receptacle into which an RJ-45 connector can be inserted. A communication cable 21A1 is connected to the first connector 101.

A pulse transformer 102 is connected to the first connector 101 and is also connected to a PHY (Ethernet physical layer transceiver) device 103.

The pulse transformer 102 has a primary winding and a secondary winding, and receives the various signals (an activation signal, an image signal, and the like) from the outside (the LED controller 4 ) via the first connector 101. The pulse transformer 102 supplies the various signals to the PHY device 103 via the primary winding and the secondary winding. The pulse transformer 102 outputs various signals to the subsequent stage via the primary winding and the secondary winding, and thus the intrusion of a high voltage or the like input from the first connector 101 is cut off, and a high voltage or the like is prevented from being transmitted to the inside of the device to protect the device.

The PHY device 103 is connected to the pulse transformer 102, a central processing unit (CPU) 104, a PHY device 106, and an EtherMAC (media access controller) 107.

The PHY device 103 receives an Ethernet signal via the pulse transformer. The Ethernet signal includes the various signals such as an activation signal and an image signal. The PHY device 103 converts an analog signal supplied from the pulse transformer 102 into a digital signal and outputs the digital signal to the CPU 104, the PHY device 106, and the EtherMAC 107.

The PHY device 103 has a circuit that detects whether or not the various signals input from the pulse transformer 102 include an activation signal (for example, a WOL command). When the PHY device 103 detects the activation signal (for example, the WOL command), the PHY device generates an interrupt signal and outputs the generated interrupt signal to the CPU 104.

The PHY device 103 outputs an image signal that is to be displayed in the LED module in which the PHY device 103 itself is installed of the image signals included in the Ethernet signal to the EtherMAC 107 and supplies an image signal that is not to be displayed in the LED module in which the PHY device 103 itself is installed (an image signal that is to be displayed by the LED module 10 in the subsequent stage) to the PHY device 106.

The CPU 104 is connected to the PHY device 103, a buffer circuit 105, and an image and control data signal processing unit 108.

When the CPU 104 receives the interrupt signal based on the activation signal (for example, the WOL command) from the PHY device 103, the CPU 104 determines that an instruction to activate has been acquired from the LED controller 4, generates the power supply control signal, and outputs the generated power supply control signal to the buffer circuit 105.

In addition, the CPU 104 acquires an OFF command from the image and control data signal processing unit 108. When the CPU 104 acquires the OFF command, the CPU 104 outputs the power supply control signal for turning off the power supply to the buffer circuit 105.

The buffer circuit 105 is connected to the CPU 104 and the terminal 22t2. The terminal 22t2 is connected to the second path 22A2. As a result, the buffer circuit 105 can transmit the power supply control signal to the LED module connected thereto in the next stage via the second path 22A2.

Here, in a step in which the activation signal is not input, the PHY device 103 and the CPU 104 wait for the activation signal in a state in which the PHY device 103 and the CPU 104 are activated with the power supplied from the power supply unit in order to detect whether or not the activation signal is input and to generate the power supply control signal.

The PHY device 106 is connected to the PHY device 103 and a pulse transformer 109. The PHY device 106 outputs the image signal supplied from the PHY device 103 to the pulse transformer 109.

The pulse transformer 109 is connected to the PHY device 106 and a second connector 110.

The pulse transformer 109 has a primary winding and a secondary winding and supplies the image signal input from the PHY device 106 to the second connector 110 via the primary winding and the secondary winding. The pulse transformer 109 outputs the image signal to the subsequent stage via the primary winding and the secondary winding, and thus it is possible to prevent a high voltage or the like from being transmitted to the subsequent stage.

The second connector 110 is connected to the pulse transformer 109 and the terminal 21t2. The terminal 21t2 is connected to the first path 21A2. As a result, the second connector 110 can transmit the image signal to the LED module connected thereto in the next stage via the first path 21A2.

The EtherMAC 107 is connected to the PHY device 103 and the image and control data signal processing unit 108. The EtherMAC 107 acquires an image signal to be displayed on the LED module in which the EtherMAC 107 itself is provided from the PHY device 103 and supplies the image signal to the image and control data signal processing unit 108.

The image and control data signal processing unit 108 is connected to the EtherMAC 107, the CPU 104, and the display unit.

The image and control data signal processing unit 108 drives the LEDs of the display unit on the basis of the image signal supplied from the EtherMAC 107 to cause the display unit 10b1 to display an image based on the image signal.

In a case in which an OFF command is included in the image signal supplied from the EtherMAC 107, the image and control data signal processing unit 108 supplies the OFF command to the CPU 104. In addition, in the case in which an OFF command is included in the image signal supplied from the EtherMAC 107, the image and control data signal processing unit 108 causes the display unit 10b1 not to display an image based on the image signal.

Here, a case in which a WOL command is used as the activation signal has been described, but the activation signal may be an ON command instead of the WOL command. In this case, the PHY device 103 does not detect a WOL command, but when the image and control data signal processing unit 108 detects that an ON command is included in the image signal supplied from the EtherMAC 107, the image and control data signal processing unit 108 supplies the ON command to the CPU 104. As a result, the CPU 104 generates a power supply control signal on the basis of the ON command. In addition, in a case in which the image and control data signal processing unit 108 detects the image signal supplied from the EtherMAC 107, the image and control data signal processing unit 108 causes the display unit 10b1 to display an image based on the image signal.

In the embodiment described above, a case in which the PHY device 103 and the CPU 104 in the signal processing unit 10c11 shown in FIG. 9 wait for the activation signal in a state in which the PHY device 103 and the CPU 104 are activated with the power supplied from the power supply unit has been described.

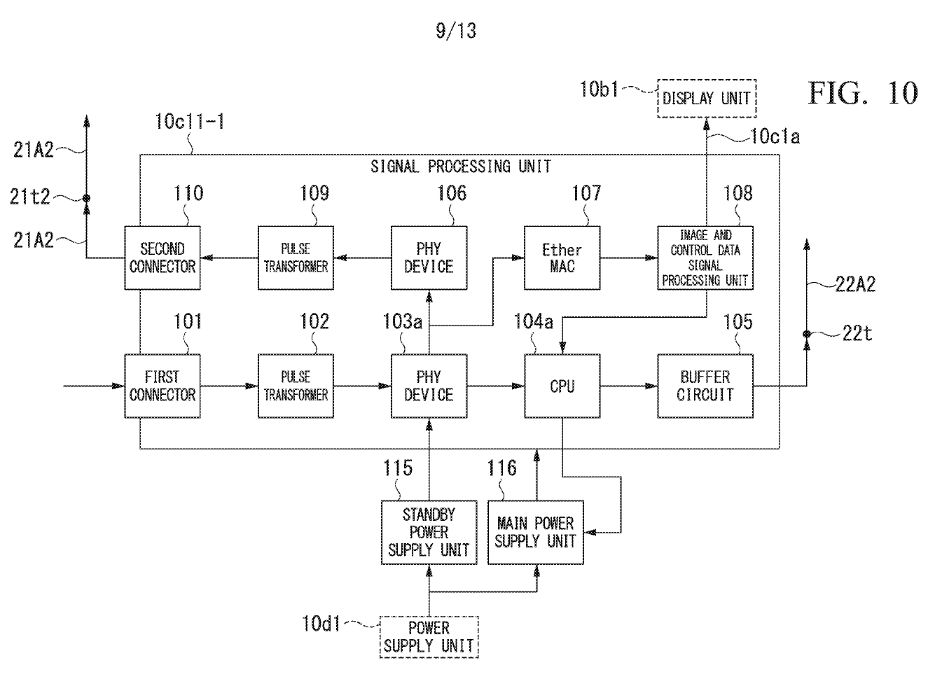

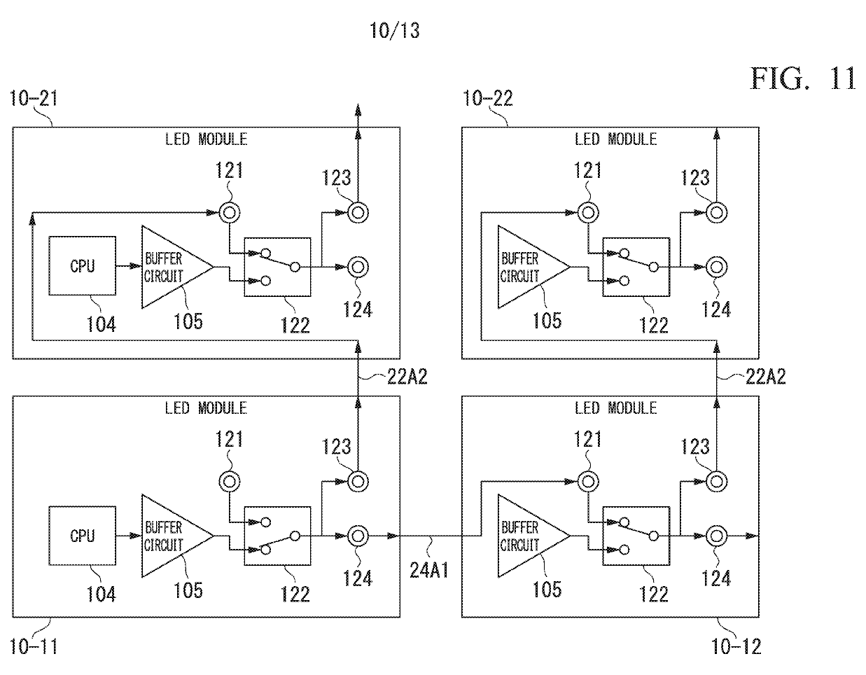

FIG. 10 is a functional block diagram showing a schematic configuration of a signal processing unit 10c11-1, which is another configuration of the signal processing unit 10c11 described above.

In the signal processing unit 10c11-1, the same constituent elements as those in the signal processing unit 10c11 are denoted by the same reference signs, and the descriptions thereof will be omitted.

A standby power supply unit 115 is connected to the power supply unit 10d11 and a PHY device 103a and supplies power supplied from the power supply unit 10d11 to the PHY device 103a. The standby power supply unit 115 supplies standby power, which is power that allows a standby state to be maintained, to the PHY device 103a and a CPU 104a.

The PHY device 103a is connected to the standby power supply unit 115, a pulse transformer 102, a PHY device 106, a EtherMAC 107, and the CPU 104a.

The PHY device 103a is driven by receiving the standby power supplied from the standby power supply unit 115 until an activation signal is input from the LED controller 4 and has a detection unit that detects whether or not the activation signal has been input. The PHY device 103a transitions to the standby state until the activation signal is input from the LED controller 4. In a case in which the activation signal is not input, the PHY device 103a does not output a signal indicating that the activation signal has been input to the CPU 104a. On the other hand, in a case in which the PHY device 103a detects that the activation signal has been input, the PHY device 103a outputs a signal indicating that the activation signal has been detected to the CPU 104a and transitions to a normal state.

The CPU 104a is connected to the PHY device 103a, a buffer circuit 105, an image and control data signal processing unit 108, and a main power supply unit 116.

The CPU 104a has a control unit that is driven with power supplied from the standby power supply unit 115. The control unit stops driving the power supply unit 10d11 until the PHY device 103a detects the activation signal, and performs driving the power supply unit 10d11 when the PHY device 103a detects that the activation signal has been supplied.

In a state in which the activation signal is not detected in the PHY device 103a, the CPU 104a stops the main power supply unit 116 and transitions to a standby state, and when the CPU 104a receives a signal indicating that the activation signal has been detected from the PHY device 103a, the CPU 104a activates the main power supply unit 116 and transitions to a normal state.

In addition, in a state in which the activation signal is not input (or in a case in which an OFF command is input), the CPU 104a receives the power from the PHY device 103a or the standby power supply unit 115 and is driven in the standby state. Here, the PHY device 103a supplies the power supplied from the standby power supply unit 115 to the CPU 104a. However, in a case in which the CPU 104a can receive the power directly from the standby power supply unit 115, the PHY device 103a does not need to supply the power to the CPU 104a.

The main power supply unit 116 is connected to the power supply unit 10d11, the CPU 104a, and the signal processing unit 10c11-1. The main power supply unit 116 can switch between supplying and not supplying the power to the signal processing unit 10c11-1 on the basis of an instruction from the CPU 104a. When an instruction to supply the power is input from the CPU 104a, the main power supply unit 116 supplies the power supplied from power supply unit 10d11 to the signal processing unit 10c11-1. As a result, the entire signal processing unit 10c11-1 transitions to a drivable state.

Here, in a case in which the activation signal is not input to the signal processing unit 10c11-1, the power that allows the standby state to be maintained is supplied from the standby power supply unit 115 to the PHY device 103a. As a result, the PHY device 103a and the CPU 104a transition to the standby state until the activation signal is detected. As a result, until the activation signal is detected, the entire signal processing unit 10c11-1 is not activated, and power that allows the PHY device 103a and the CPU 104a to operate only has to be supplied, and thus it is possible to save power for the LED module in the forefront in the row of the LED display device 1 (the LED module connected to the LED controller 4).

According to this embodiment, since the power supply unit is configured to be divided into the standby power supply unit 115 and the main power supply unit 116, the CPU 104a can stop the main power supply unit and limit the supply of power to other circuits until the PHY device 103a detects the activation signal (the WOL command or the like). As a result, it is possible to save power.

Next, an example of a configuration in which the signal processing unit 10c11 outputs the power supply control signal to an adjacent LED module 10 will be described.

FIG. 11 is a schematic functional block diagram illustrating a configuration for outputting the power supply control signal. In this drawing, the constituent elements around the CPU 104 of the signal processing unit 10c11 in FIG. 9 will be described, but another constituent element such as the PHY device 103 is not shown.

In addition, the LED module 10-11 shown in this drawing has a configuration that can be applied to the LED module 10 in the first stage in each row.

The buffer circuit 105 of the LED module 10-11 is connected to the CPU 104 and a switch 122. The buffer circuit 105 supplies the power supply control signal supplied from the CPU 104 to the switch 122 with reduced output impedance.

A power supply control signal input terminal 121 is connected to a first input terminal of the switch 122 and is connectable to the supply path for the power supply control signal supplied from the outside. The power supply control signal input terminal 121 of the LED module 10-11 is not connected to the supply path for the power supply control signal.

In the switch 122 of the LED module 10-11, the first input terminal is connected to the power supply control signal input terminal 121, and a second input terminal is connected to an output terminal of the buffer circuit 105, and any one of the first input terminal and the second input terminal is selected for connection. In addition, the output of the switch 122 is supplied to a longitudinal output terminal 123 and a lateral output terminal 124.

As a result, the switch 122 supplies the power supply control signal, which is supplied via a terminal selected from the first input terminal and the second input terminal, to each of the longitudinal output terminal 123 and the lateral output terminal 124. In the switch 122, connection to any one of the first input terminal and the second input terminal can be manually switched by a physical switch.

The switch 122 supplies a signal, which is input from a terminal selected from the first input terminal and the second input terminal, to the longitudinal output terminal 123 and the lateral output terminal 124. The switch 122 of the LED module in the first stage in the row is set to be connected to the second input terminal (the buffer circuit 105). Each of switches 122 of the LED modules in the second and succeeding stages in each row is set to be connected to a power supply control signal input terminal. Nothing is connected to the power supply control signal input terminal 121 of the LED module 10-11.

The longitudinal output terminal 123 is connected to a power supply control signal input terminal 121 of the LED module 10-21 in the next stage in the same row via the second path 22A2. That is, the longitudinal output terminal 123 can be connected to the signal processing unit of the LED module arranged in the subsequent stage in a row direction via the second path.

As a result, the power supply control signal supplied from the buffer circuit 105 of the LED module 10-11 is supplied to the switch 122 of the LED module 10-21 via the second path 22A2 connected to the longitudinal output terminal 123 and the power supply control signal input terminal 121 of the LED module 10-21. Therefore, it is possible to make the configurations of the signal processing units of the LED module 10-11 provided in the first stage and the LED modules provided in the second and succeeding stages (the LED module 10-21, the LED module 10-31, and the like) common, and when the switch 122 is switched, it is possible to select the supply path of the power supply control signal for each of the LED modules in the first stage and the second and succeeding stages (the LED module 10-21, the LED module 10-31, and the like).

The lateral output terminal 124 is a terminal that is connectable to the power supply control signal input terminal 121 of the LED module 10-12 disposed in the same column in a column direction and in an adjacent row (here, as an example, on the right side) via a fourth path 24A1.

A second input terminal of a switch 122 of the signal processing unit 10c12 is connected to an output terminal of the buffer circuit 105 of the LED module 10-11. Here, the switch 122 of the signal processing unit 10c12 is selected to be connected to a first input terminal and is therefore selected to be able to receive the power supply control signal supplied from the signal processing unit 10c11 provided to be adjacent to the left side. For this reason, the switch 122 supplies the power supply control signal to a longitudinal output terminal 123 and a lateral output terminal 124 of the signal processing unit 10c12. The lateral output terminal 124 of the signal processing unit 10c12 is connected to a power supply control signal input terminal of the LED module 10-13 adjacent to the right side. As a result, the power supply control signal is supplied to the LED module in a first stage in the adjacent row.

The power supply control signal input terminal 121 of the LED module 10-12 is connected to the lateral output terminal 124 of the LED module 10-11 adjacent to the left side via the second path and is also connected to the first input terminal of the switch 122. The switch 122 of the LED module 10-12 is switched to be connected to a side of the power supply control signal input terminal 121. Thereafter, with respect to the LED module adjacent to the right side among the LED modules in the first stages in each row, connection is similarly made, and the switch 122 is switched to a side of the power supply control signal input terminal 121. With respect to the LED module disposed at the most right side of the LED display device 1, the lateral output terminal 124 is not connected to the next LED module because there is no LED module connected to the right side.

The longitudinal output terminal 123 of the LED module 10-21 is connected to the signal processing unit of the LED module in the next stage, but the lateral output terminal 124 is not connected to the LED module adjacent to the right side. In other words, the lateral output terminal 124 of the LED module in a stage subsequent to the second stage is not connected to the LED module adjacent to the right side. In addition, the longitudinal output terminal 123 of the LED module in the last stage in each row is not connected to the LED module in the next stage because there is no LED module in the next stage.

In order to protect the buffer circuit 105, in a case in which the buffer circuit 105 and the switch 122 are connected to each other, the connection may be made via a current protection circuit. For simplicity, a resettable fuse (a positive temperature coefficient (PTC) thermistor using a conductive polymer) may be used therefor.

According to this embodiment, a signal path subsequent to the buffer circuit 105 is set in advance using the switch 122, and thus it is possible to switch between receiving the power supply control signal from the LED module connected to the previous stage (or the previous column) and receiving the power supply control signal from the CPU of the LED module itself. As a result, it is possible not only to use the power supply control signal output from the CPU 104 of a certain LED module in the LED module itself, but also to supply the power supply control signal to another LED module. As a result, it is possible to make the configurations of the LED module in the first stage and the LED modules in the second and succeeding stages common. In addition, the CPU 104 of each of the LED modules in the second and succeeding stages does not need to generate the power supply control signal, and thus it is possible to reduce power consumption.

According to this embodiment, the LED module 10-11 and the LED module 10-21 are disposed to be adjacent to each other, and the LED module 10-12 which is in a series different from and in a stage next after the LED module 10-21 is disposed to be adjacent to the LED module 10-11. The LED module 10-11 is further provided with the fourth path 24A1 which is connected to a power supply unit of the LED module 10-12 and through which a power supply control signal for supplying power from the power supply unit of the LED module 10-12 to a signal processing unit of the LED module 10-12 is supplied. Since the fourth path 24A1 is provided, it is possible to supply the power supply control signal to the LED module in a subsequent stage in a row to which the LED module generating the power supply control signal belongs, and it is also possible to supply the power supply control signal to the LED module in a row adjacent to the LED module generating the power supply control signal. As a result, there is no need to necessarily provide one LED module for generating the power supply control signal for each row.

In this embodiment, a case in which the LED module 10-11 is connected to two LED modules, one in the stage above the LED module 10-11 in the row direction and one adjacent to the right side of the LED module 10-11 in the column direction has been described, but three or more LED modules may be connected to one LED module. For example, one LED module may be connected to three or four LED modules among the LED modules on the upper side and the lower side of the one LED module in the row direction and the LED modules on the right side and the left side of the one LED module in the column direction. In this case, the longitudinal output terminals 123 and the lateral output terminals 124 may be increased according to the number of the LED modules to be connected.

Next, another example of a configuration in which the LED module 10-11 outputs the power supply control signal to an adjacent LED module 10 will be described.

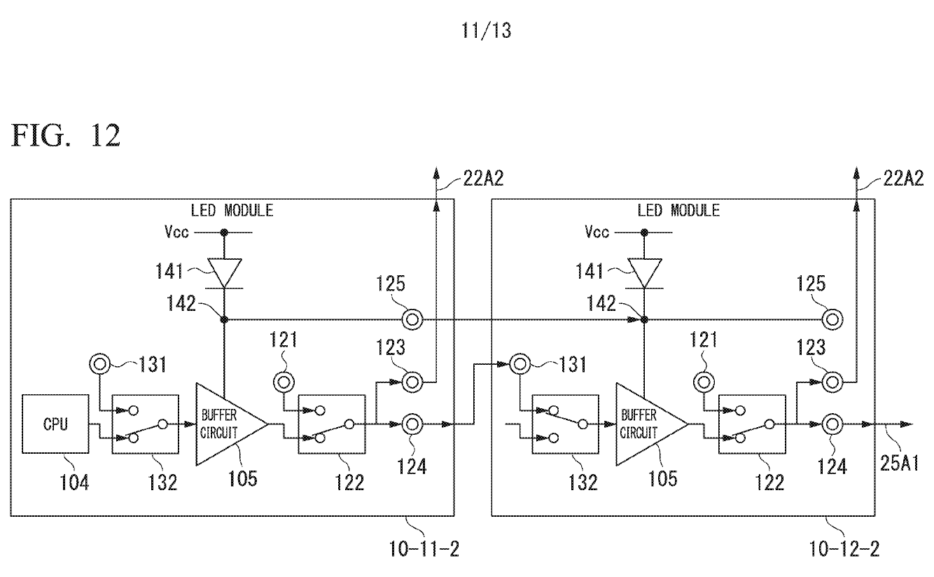

FIG. 12 is a schematic functional block diagram illustrating another example of a configuration in which the LED module 10-11 outputs the power supply control signal. In this drawing, another example of the constituent elements around the CPU 104 of the LED module 10-11 in FIG. 9 will be described, but another constituent element such as the PHY device 103 is not shown. In addition, the same constituent elements as those in FIG. 11 are denoted by the same reference signs, and the description thereof will be omitted.

In an LED module 10-11-2, an input terminal of a diode 141 is connected to a power supply Vcc of a signal processing unit 10c11-2, and an output terminal of the diode 141 is connected to a connection point 142.

A positive power supply terminal of the buffer circuit 105 is connected to the connection point 142. The buffer circuit 105 can be driven with power supplied from the power supply Vcc.

A lateral side power supply terminal 125 is connected to the connection point 142 and is also connected to a connection point 142 of a signal processing unit 10c12-2 of an LED module provided to be adjacent in a right direction.

A switch 132 is connected between the CPU 104 and the buffer circuit 105. More specifically, a first input terminal of the switch 132 is connected to a power supply control signal input terminal 131, and a second input terminal of the switch 132 is connected to an output terminal of the CPU 104. An output terminal of the switch 132 is connected to an input terminal of the buffer circuit 105. In the switch 132, connection to any one of the first input terminal and the second input terminal can be manually switched by a physical switch. The switch 132 of the signal processing unit 10c11-2 is switched to connect to the second input terminal.

A power supply control signal input terminal 131 of an LED module 10-12-2 is connected to a lateral output terminal 124 of the signal processing unit 10c11-2 via a second path 25A1. A switch 132 of the signal processing unit 10c12-2 is switched to connect to a first input terminal.

In addition, a positive power supply terminal of a buffer circuit 105 of the LED module 10-12-2 is connected to the connection point 142 of the LED module 10-12-2. The buffer circuit 105 of the LED module 10-12-2 can be driven by receiving a voltage supplied from the connection point 142 to supply a power supply control signal input via the lateral output terminal 124 of the LED module 10-11-2 provided to be adjacent thereto via the power supply control signal input terminal 131 to a second input terminal of the switch 122 connected thereto in the subsequent stage. As a result, the LED module 10-12-2 can acquire the power supply control signal from the LED module 10-11-2 provided to be adjacent thereto without the need for the CPU 104 provided in the LED module 10-12-2 to generate the power supply control signal.

In addition, according to this embodiment, in a case in which the input impedance of the LED module connected to the longitudinal output terminal 123 and the lateral output terminal 124 is low, it is possible to supply power from the LED module 10-11-2 (the LED module provided in the first stage in the row) to the buffer circuit 105 of the next LED module (the LED module connected thereto in the subsequent stage in the row, the adjacent LED module connected to the right side).

Here, the LED module adjacent to the LED module of which the power supply unit is activated may not be able to operate depending on the impedance. Meanwhile, even when the power supply unit is in an off state, the LED module adjacent to the LED module of which the power supply unit is activated may not be able to operate with only the control signal supplied from the buffer in the previous stage (or the adjacent LED module in the lateral direction). Even in such a case, the power supplied to the previous stage (or the adjacent LED module in the lateral direction) can be supplied to the next stage (or the adjacent LED module in the lateral direction) to drive the next stage. Here, it is possible to supply the power to the adjacent LED module via the lateral side power supply terminal 125.

In addition, the standby power for the signal processing unit described in this embodiment can be supplied from another LED module, activation with the activation signal (the WOL command or the like) can be performed for each row, and the entire LED display can be configured to reduce power consumption.

In addition, according to this configuration, in order to prevent current leakage to circuits other than the buffer circuit 105, the power can be supplied from the power supply Vcc via the diode 141.

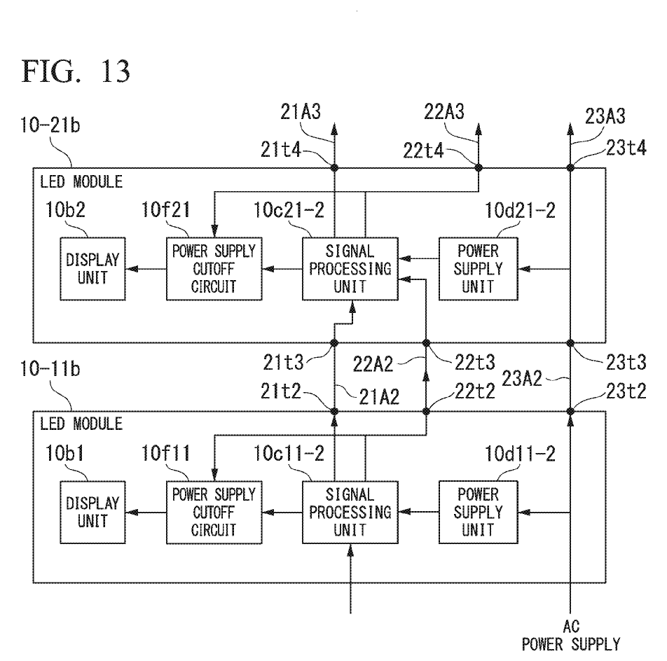

Next, FIG. 13 is a functional block diagram showing another configuration of the LED module 10. In this drawing, another configuration example of the LED module 10-11 and the LED module 10-21 in FIG. 4 will be described. In addition, in an LED module 10-11b, the same constituent elements as those in the LED module 10-11 of FIG. 4 are denoted by the same reference signs, and the description thereof will be omitted. In addition, in an LED module 10-21b, the same constituent elements as those in the LED module 10-21 of FIG. 4 are denoted by the same reference signs, and the description thereof will be omitted.

The LED module 10-11b includes a power supply unit 10d11-2, a signal processing unit 10c11-2, a power supply cutoff circuit 10f11, and a display unit 10b1. In addition, the LED module 10-11b is provided with a terminal 21t2, a terminal 22t2, and a terminal 23t2.

The power supply unit 10d11-2 converts AC power supplied from the outside into DC power and outputs the converted DC power to the signal processing unit 10c11-2. Here, the power supply unit 10d11-2 is not provided with a circuit that turns on and off on the basis of the power supply control signal, such as the switch unit 10d11b shown in FIG. 5 and the AC relay d11d and the relay control circuit 10d11c shown in FIG. 7.

The signal processing unit 10c11-2 has the functions of the signal processing unit 10c11-1, the standby power supply unit 115, and the main power supply unit 116 shown in FIG. 10.

When the signal processing unit 10c11-2 receives a Wake-on-LAN packet (an activation signal) from the LED controller 4, the signal processing unit 10c11-2causes a PHY device (103) and a CPU (104) in the signal processing unit 10c11-2 to transition from a standby state to a normal state.

When the signal processor 10c11-2 transitions to the normal state, the signal processing unit 10c11-2 generates a power supply control signal to turn on the power supply cutoff circuit 10f11, thereby causing the supply of power from the power supply cutoff circuit 10f11 to the display unit 10b1 to be performed.

In addition, when the signal processing unit 10c11-2 generates the power supply control signal, the signal processing unit 10c11-2 supplies the power supply control signal to a signal processing unit 10c21-2 of the LED module 10-21b in the next stage in the same row via a second path 22A2 and also supplies the power supply control signal to the power supply cutoff circuit 10f11.

In a case in which the signal processing unit 10c11-2 transitions from the normal state to the standby state, in a state in which a unique OFF command is set in advance between the LED controller 4 and the signal processing unit 10c11-2, when the signal processing unit 10c11-2 acquires this OFF command from the LED controller 4, the signal processing unit 10c11-2 transitions to the standby state.

When the signal processing unit 10c11-2 receives the OFF command from the LED controller, the signal processing unit 10c11-2 generates a power supply control signal for turning off the power supply and outputs the generated power supply control signal to the power supply cutoff circuit 10f11. As a result, the power supply cutoff circuit 10f11 turns off the power supply and stops the supply of power to the display unit 10b1.

In addition, when the signal processing unit 10c11-2 receives the OFF command from the LED controller, the signal processing unit 10c11-2 causes the PHY device (103) and the CPU (104) to transition from the normal state to the standby state.

The LED module 10-21b includes a power supply unit 10d21-2, a signal processing unit 10c21-2, a power supply cutoff circuit 10f21, and a display unit 10b2. In addition, the LED module 10-21b is provided with a terminal 21t3, a terminal 22t3, a terminal 23t3, a terminal 21t4, a terminal 22t4, and a terminal 23t4.

The power supply unit 10d21-2 converts AC power supplied from the outside into DC power and outputs the converted DC power to the signal processing unit 10c21-2. Here, the power supply unit 10d21-2 is not provided with a circuit that turns on and off on the basis of the power supply control signal, such as the switch unit 10d11b shown in FIG. 5 and the AC relay d11d and the relay control circuit 10d11c shown in FIG. 7.

When the signal processor 10c21-2 receives a power supply control signal from the LED module 10-11b connected to the previous stage in the same row, the signal processing unit 10c21-2 causes a PHY device (103) and a CPU (104) to transition from a standby state to a normal state. Here, an LED module (for example, the LED module 10-21b) in a stage subsequent to and connected to an LED module in the first stage (for example, the LED module 10-11b) connected to the LED controller 4 cannot receive a Wake-on-LAN packet (an activation signal) because the LED module in the first stage is in the standby state.

When the signal processing unit 10c21-2 receives the activation signal from the LED module connected in the previous stage, the signal processing unit 10c21-2 causes the PHY device (103) and the CPU (104) in the signal processing unit 10c21-2 to transition from the standby state to the normal state. When the signal processor 10c21-2 transitions from the standby state to the normal state, the signal processing unit 10c21-2 generates a power supply control signal to turn on the power supply cutoff circuit 10f21, thereby causing the supply of power from the power supply cutoff circuit 10f21 to the display unit 10b2 to be performed.

In addition, when the signal processing unit 10c21-2 generates the power supply control signal, the signal processing unit 10c21-2 supplies the power supply control signal to a signal processing unit of the LED module in the next stage in the same row via a second path 22A3 and also supplies the power supply control signal to the power supply cutoff circuit 10f21.

In a case in which the signal processing unit 10c21-2 transitions from the normal state to the standby state, when the signal processing unit 10c21-2 acquires the above described OFF command from the signal processing unit 10c11-2, the signal processing unit 10c21-2 transitions to the standby state. In addition, when the signal processing unit 10c21-2 acquires a power supply control signal for turning off the power supply from the signal processing unit 10c11-2, the signal processing unit 10c21-2 may transition to the standby state.

When the signal processing unit 10c21- 2receives the OFF command from the LED controller or receives the power supply control signal from the LED module in the previous stage, the signal processing unit 10c21-2 generates a power supply control signal for turning off the power supply and outputs the generated power supply control signal to the power supply cutoff circuit 10f21. As a result, the power supply cutoff circuit 10f21 turns off the power supply and stops the supply of power to the display unit 10b2.

In addition, when the signal processing unit 10c21-2 receives the OFF command or the power supply control signal for turning off the power supply from the LED module in the previous stage, the signal processing unit 10c21-2 causes the PHY device (103) and the CPU (104) to transition from the normal state to the standby state.

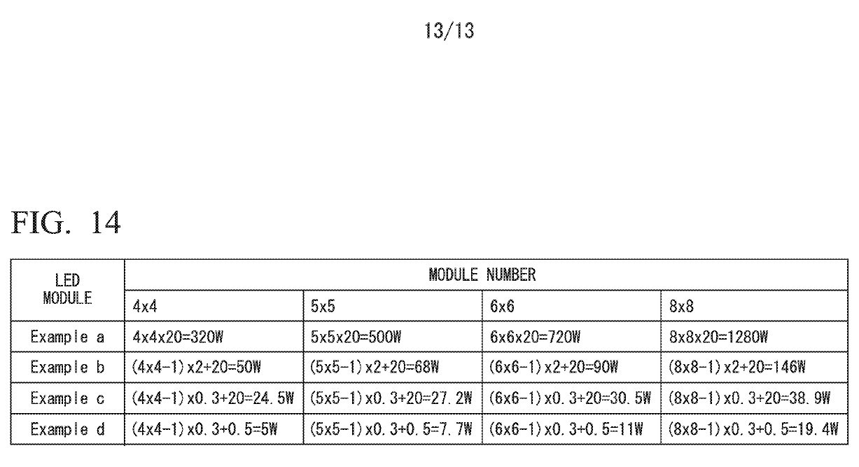

FIG. 14 is a diagram showing an example of calculation of how much power is reduced in the LED display device described above.

In this example, a case in which the relationship between the configuration of one LED module and the power consumption thereof is as follows will be described.

(Example a) Power consumption of an LED module of the related art in a case in which one LED module displays all black: 20 W

(Example b) Power consumption of an LED module having the power supply unit shown in FIG. 5 in a case in which the DC output of the LED module is turned off: 2 W

(Example c) Power consumption of an LED module having the power supply unit shown in FIG. 6 in a case in which the AC relay of the LED module is turned off: 0.3 W

(Example d) Power consumption of an LED module which has the power supply unit shown in FIG. 6 in a case in which the AC relay of the LED module is turned off and to which the signal processing unit shown in FIG. 10 is applied: 0.5 W

Here, the LED display device was made using a plurality of the LED modules according to any one of the above-described Examples a to d, and in this case, calculations were performed for four type arrangements in number such as a 4×4 arrangement, a 5×5 arrangement, a 6×6 arrangement, and an 8×8 arrangement. The 4×4 arrangement is a case in which 16 LED modules in total are arranged in a matrix of 4 LED modules in the longitudinal direction and 4 LED modules in the lateral direction. Similarly, the 5×5 arrangement is a case in which 25 LED modules in total are arranged in a matrix of 5 LED modules in the longitudinal direction and 5 LED modules in the lateral direction. The 6×6 arrangement is a case in which 36 LED modules in total are arranged in a matrix of 6 LED modules in the longitudinal direction and 6 LED modules in the lateral direction. The 8×8 arrangement is a case in which 64 LED modules in total are arranged in a matrix of 8 LED modules in the longitudinal direction and 8 LED modules in the lateral direction.

(Regarding Example a)

When power is supplied from the power distribution board, all of the LED modules transition to a drive state. Here, even in a case in which no image based on the image signal is supplied, power is consumed to display the entire screen in black. In the case of the 4×4 arrangement, the power consumption in total is 320 W, and as the arrangement number of the LED modules increases, the power consumption increases. In the case of the 8×8 arrangement, the power consumption in total is 1280 W.

(Regarding Example b)

In a state in which power is supplied from the power distribution board and no image signal is supplied, one LED module is driven in the normal state, but in the LED modules other than the one LED module, the DC output of the power supply unit is stopped. In the case of the 4x4 arrangement, the power consumption in total is 50 W, and in the case of the 8x8 arrangement, the power consumption in total is 146 W. For this reason, compared to Example a, in the case of the 8x8 arrangement, the reduced power consumption is 1134 W.

(Regarding Example c)

In a state in which power is supplied from the power distribution board and no image signal is supplied, one LED module is driven in the normal state, but in the LED modules other than the one LED module, the AC relay of the power supply unit is turned off. In the case of the 4x4 arrangement, the power consumption in total is 24.5 W, and in the case of the 8x8 arrangement, the power consumption in total is 38.9 W. For this reason, compared to Example a, in the case of the 8x8 arrangement, the reduced power consumption is 1241.1 W.

(Regarding Example d)

In a state in which power is supplied from the power distribution board and no image signal is supplied, one LED module is driven in the standby state, but in the LED modules other than the one LED module, the AC relay of the power supply unit is turned off. In the case of the 4x4 arrangement, the power consumption in total is 5 W, and in the case of the 8x8 arrangement, the power consumption in total is 19.4 W. For this reason, compared to Example a, in the case of the 8x8 arrangement, the reduced power consumption is 1260.6 W.

In this way, compared to the configuration of the related art, in the configurations of the present embodiment, it is possible to reduce the power consumption in all of the cases. In addition, as the arrangement number of the LED modules increases, the reduction in power consumption increases.

In the LED display device of the related art, the AC power supplies of the LED modules arranged in the row direction are connected in series to a power distribution board. In a case in which AC power is supplied, various circuits in an LED module operates and consumes power even in a state in which no image is displayed. Furthermore, the LED display device is configured to include a plurality of LED modules, and thus the power consumption in a case in which no image is displayed cannot be ignored because the power consumption of the entire LED display device increases as the number of the LED modules increases. In contrast, according to the embodiment described above, one LED module generates the power supply control signal on the basis of the activation signal received from the LED controller and supplies the generated power supply control signal to the other LED modules. As a result, when the other LED modules receive this power supply control signal, the other LED modules only have to transition from the standby state to the normal state. For this reason, in a state in which the other LED modules do not display the image signal, the other LED modules can transition to the standby state rather than the normal state, and thus it is possible to reduce the power consumption. Here, in a case in which the LED module is in the standby state, the signal processing unit cuts off the supply of power to the display unit. As a result, even in a state in which the power supply unit is activated, power is not supplied to at least the display unit, and thus it is possible to reduce the power consumption so much. In addition, when the power supply unit is put into a non-activation state, it is possible to further reduce the power consumption.

In this way, in addition to the path (the first path) through which the image signal is supplied and the path (the third path) through which the AC power is supplied, the path (the second path) through which the power supply control signal is supplied is provided, and the function of each LED module is activated or stopped on the basis of this power supply control signal, and thus it is possible to reduce the power consumption.

In addition, the LED display device of the related art is configured to include a plurality of LED modules, and thus when the power supply units of the LED modules are turned on simultaneously, a large inrush current occurs. In contrast, according to the embodiment described above, the delay circuit is provided in the LED module, and thus the LED module is not activated immediately after the power supply control signal is received from the LED module in the previous stage, but the LED module is activated after a set delay time has elapsed. For this reason, it is possible to set the activation timing to a different timing from that of the LED module in the previous stage, and thus it is possible to reduce the inrush current.

In addition, a program for realizing the functions of the processing unit in FIG. 1 may be recorded on a computer-readable recording medium, and the program recorded on the recording medium may be read and executed by a computer system to perform construction management. The term “computer system” as used herein includes an OS and hardware such as peripheral devices.

In addition, the “computer system” also includes a homepage providing environment (or a display environment) in a case in which a WWW system is used.

In addition, the “computer-readable recording medium” is a storage device such as a portable medium, for example, a flexible disk, a magneto-optical disk, a ROM, or a CD-ROM, or a hard disk built in the computer system. Furthermore, examples of the “computer-readable recording medium” include a volatile memory inside the computer system which serves as a server or client and holds the program for a certain period of time. In addition, the program may be for realizing a part of the functions described above and may be capable of realizing the functions described above in combination with a program already recorded in the computer system. In addition, the program may be stored in a predetermined server, and the program may be distributed (downloaded or the like) via a communication line in response to a request from another device.

In the above, the embodiments of this invention have been described in detail with reference to the drawings, but the specific configuration is not limited to the embodiments, and a design and the like within a range not departing from the gist of this invention are also included.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 LED display device

2 Power distribution board

3 Image signal supply device

4 LED controller

10, 10-11, 10-11-2, 10-11b, 10-12, 10-12-2, 10-13, 10-14, 10-15, 10-16, 10-21, 10-21a, 10-21b, 10-22, 10-31, 10-41, 10-51, 10-61 LED module

10-13G, 10-14G Module group

10a LED substrate

10b, 10b1, 10b2 Display unit

20b1 Display unit

10c11a, 10d1a Connection line

10c12, 10c12-2, 10c2, 10c21, 10c21-2 Signal processing unit

10d, 10d1, 10d11, 10d11-2, 10d2, 10d21, 10d21-2 Power supply unit

10d1-1 ON signal supply unit

10d11a AC-DC conversion unit

10d11b Switch unit

10d11c Relay control circuit

10d11d AC relay

10e Delay circuit

10ele LED element

10f11, 10f21 Power supply cutoff circuit

10mod Signal processing module

13 LED module

21A1, 21B1 Communication cable

21, 22, 23A, 23A1 Power supply line

21A2, 21A3 First path

21t1, 21t2, 21t3, 21t4, 22t2, 22t3, 22t4, 23t1, 23t2, 23t3, 23t4 Terminal

22A2, 22A3, 25A1 Second path

22A21 Supply path

23A2, 23A3 Third path

24A1 Fourth path

101 First connector

102, 109 Pulse transformer

103, 103a, 106 PHY device

105 Buffer circuit

108 Image and control data signal processing unit

110 Second connector

115 Standby power supply unit

116 Main power supply unit

121, 131 Power supply control signal input terminal

122, 132 Switch

123 Longitudinal output terminal

124 Lateral output terminal

125 Lateral side power supply terminal

141 Diode

142 Connection point

S Display system

What is claimed is:

1. An LED display device comprising: an array of a plurality of LED modules, wherein each of the plurality of LED modules comprises:
a display unit including a plurality of LED elements;
a signal processing unit configured to cause the display unit to display an image based on an image signal supplied from an external device; and
a power supply unit configured to supply, to at least the signal processing unit, power that has been supplied from the outside,
wherein the plurality of LED modules comprises a first LED module, and a second LED module connected to the first LED module,
wherein the first LED module includes a first signal processing unit and a first power supply unit,
wherein the second LED module includes a second signal processing unit, and a second power supply unit,
wherein the LED display device further comprises:
a first path configured to connect the first signal processing unit and the second signal processing unit, the first path being configured to supply signals including an image signal;
a second path configured to connect the first signal processing unit and the second power supply unit, to supply a first power supply control signal which is to supply power from the second power supply unit of the second LED module to the second signal processing unit of the second LED module; and
a third path configured to connect the first power supply unit and the second power supply unit, to supply, to the second power supply unit of the second LED module, power that has been supplied from outside to the first LED module.

2. The LED display device according to claim 1, wherein the first signal processing unit of the first LED module is configured to generate the first power supply control signal upon receipt of an activation signal from the external device and configured to supply the first power supply control signal generated via the second path.

3. The LED display device according to claim 2, wherein the second LED module further comprises:
a delay circuit configured to delay a timing at which the first power supply control signal supplied from the first LED module reaches the second power supply unit of the second LED module.

4. The LED display device according to claim 3,
wherein the plurality of LED modules further comprises a third LED module which is connected to the second LED module, the third LED module comprises a third signal processing unit,
wherein the second LED module has a supply path through which the first power supply control signal is supplied to the signal processing unit of the third LED module connected thereto, and
wherein the supply path is configured to supply the first power supply control signal before being input to the delay circuit or supply the first power supply control signal delayed by the delay circuit.

5. The LED display device according to claim 4,
wherein, in the first LED module, the first power supply unit is configured to supply, to the first signal processing unit, standby-power to keep the first LED module in a standby state, and
wherein the first signal processing unit further comprises:
a detection unit that is driven by the standby power, the detection unit configured to detect whether or not the activation signal has been supplied from the external device, and
a control unit that is driven by the standby power, the control unit configured to stop the first power supply unit of the first LED module until from driving until the detection unit will have detected the activation signal, and the control unit configured to drive the power supply unit of the first LED module when the detection unit detects that the activation signal has been supplied.

6. The LED display device according to claim 1,
wherein the plurality of LED modules further comprises a fourth LED module that comprises a fourth power supply unit and a fourth signal processing unit,
wherein the first LED module and the second LED module are disposed to be adjacent to each other, and
wherein the fourth LED module is in a series different from and in a stage next to the second LED module, the fourth LED module is adjacent to the first LED module, and
wherein the first signal processing unit of the first LED module is connected to the fourth power supply unit of the fourth LED module,
wherein the LED display device further comprises:
a fourth path configured to connect the first signal processing unit and the second power supply unit and the fourth power supply unit of the fourth LED module, to supply a second power supply control signal which is to supply power from the fourth power supply unit of the fourth LED module to the first signal processing unit of the first LED module.

7. The LED display device according to claim 6,
wherein the first LED module has a first terminal at which the second path is connected to the second LED module and a second terminal at which the fourth path is connected to the fourth LED module, and
wherein the first and second power supply control signals are supplied from the signal processing unit of the first LED module to the first terminal and to the second terminal, and the first and second power supply control signals are supplied to the second LED module and to the fourth LED module.

8. The LED display device according to claim 7, wherein each LED module of the plurality of LED modules further comprises a respective switch, the respective switch is connected between a respective signal processing unit of each LED module and a respective pair of terminals which are connected to LED modules on downstream stages of the plurality of LED modules, the respective switch is configured to select one of power supply control signal which has been supplied from a respective signal processing unit of each LED module and power supply control signal which has been supplied from a LED module on the upstream stages of the plurality of LED modules, to supply, to the respective pair of terminals, the power supply control signal as selected.

9. The LED display device according to claim 1, wherein the second path is connected to the first signal processing unit of the first LED module and to any one of LED modules on downstream stages of the plurality of LED modules, and the second path is configured to supply power supply control signal for supplying power from a power supply unit of a supply target LED module among the LED modules on the downstream stages to a signal processing unit of the target LED module.
